(19) United States
(12) Patent Application Publication
(10) Pub. No.: US 2026/0334704 A1
(43) Pub. Date: Oct. 29, 2026

(54) SYSTEM FOR MANAGING THE DELIVERY OF A FOOD PRODUCT WITH ANGLED RACK DESIGN

(71) Applicant: Little Caesar Enterprises, Inc., Detroit, MI (US)

(72) Inventors: Kent A. Deemter, Hudsonville, MI (US); Kyle M. Bey, Davison, MI (US); Thomas Hennessy, Royal Oak, MI (US); Andrew Boncher, Brownstown, MI (US); Garrison James Hefter, Clawson, MI (US); Edward Joseph Gleich, III, Detroit, MI (US); David Scrivano, Detroit, MI (US); Eric Brasseur, Detroit, MI (US); R William Kneifel, II, Wixom, MI (US)

(73) Assignee: Little Caesar Enterprises, Inc., Detroit, MI (US)

(21) Appl. No.: 19/657,662

(22) Filed: Apr. 24, 2026

Related U.S. Application Data
(60) Provisional application No. 63/796,120, filed on Apr. 28, 2025.

(51) Int. Cl. A47F 3/00; A47F 3/06; A47F 7/00

(52) U.S. Cl. CPC A47F 3/001; A47F 3/06; A47F 7/0071

(57) ABSTRACT

A heated food storage locker includes a first side including a first opening, a second side opposite the first side, the second side including a second opening, a receptacle extending between the first opening and the second opening, and a rack disposed in the receptacle and configured to support a food product within the receptacle. The rack includes a first portion extending from the first side toward the second side and a second portion extending from the first portion toward the second side. The second portion is disposed at an oblique angle relative to the first portion.

### CROSS-REFERENCE TO RELATED APPLICATION

This U.S. patent application claims priority under 35 U.S.C. § 119(e) to U.S. Provisional Application 63/796,120, filed on Apr. 28, 2025. The disclosure of this prior application is considered part of the disclosure of this application and is hereby incorporated by reference in its entirety.

### TECHNICAL FIELD

This disclosure relates to a system for managing the delivery of a food product, and more particularly to a system for securing an ordered food product and/or maintaining a temperature of an ordered food product prior to delivery.

### BACKGROUND

This section provides background information related to the present disclosure and is not necessarily prior art. Restaurants and other establishments that supply prepared (e.g., cooked-to-order) food products to customers often find it desirable to prepare the food product in advance of serving the food product to the customer. For example, restaurants offering carryout or take-out food service often prepare an ordered food product before the customer arrives at the restaurant to pick up the food product. In these situations, the restaurant may place the prepared food in a staging or waiting area where it can remain until it is picked up by the customer. While known systems and methods for handling and delivering prepared food products have proven acceptable for their intended use, a continuous need in the relevant art remains for improved systems and methods for ordering, handling, and delivering prepared food products.

### SUMMARY

This section provides a general summary of the disclosure and is not a comprehensive disclosure of its full scope or all of its features.

According to one aspect, the present disclosure provides a heated food storage locker. The heated food storage locker includes a first side including a first opening, a second side opposite the first side, the second side including a second opening, a receptacle extending between the first opening and the second opening, and a rack disposed in the receptacle and configured to support a food product within the receptacle. The rack includes a first portion extending from the first side toward the second side and a second portion extending from the first portion toward the second side. The second portion disposed at an oblique angle relative to the first portion.

Implementations of this aspect of the disclosure may include one or more of the following optional features. In some implementations, the heated food storage locker further includes a user interface disposed at the second side, a first vertical distance between the user interface and an end of the second portion of the rack distal from the first portion greater than or equal to a second vertical distance between the end of the second portion of the rack and an end of an adjacent rack.

In some implementations, the first side includes a plurality of first openings that are uniformly spaced relative to one another along the first side, and the second side includes a plurality of second openings that are not uniformly spaced relative to one another along the second side, individual receptacles of a plurality of receptacles extending between corresponding ones of a plurality of first openings and corresponding ones of a plurality of second openings. In some further implementations, individual racks of a plurality of racks are disposed in corresponding ones of the plurality of receptacles, the first portions of the plurality of racks extending parallel to one another, the second portions of the plurality of racks extending non-parallel to one another to accommodate non-uniform spacing of the plurality of second openings.

In some implementations, the first portion of the rack extends perpendicular to the first side of the heated storage locker.

In some implementations, a first side wall and a second side wall respectively extend between the first side and the second side, a first support structure extending from the first side wall within the receptacle and a second support structure extending from the second side wall within the receptacle, the rack supported at the first support structure and the second support structure. In some further implementations, the first support structure and the second support structure respectively include guide rails.

In some implementations, the rack is removable from the receptacle via the second opening.

In some implementations, the rack includes a plurality of bars extending parallel to one another. In some further implementations, a space between adjacent bars of the plurality of bars of the rack is smaller than a size of the food product.

According to another aspect, the present disclosure provides a heated food storage locker. The heated food storage locker includes a first side including a first opening and a second opening, a second side opposite the first side, the second side including a third opening and a fourth opening, a device disposed at the second side and at least partially vertically aligned with the first opening, a first receptacle extending between the first opening and the third opening, the third opening disposed at least partially vertically above the first opening, a second receptacle extending between the second opening and the fourth opening, the fourth opening disposed at least partially vertically above the second opening, and a rack disposed between the first receptacle and the second receptacle and configured to support a food product within the second receptacle. The rack includes a first portion extending from the first side toward the second side and a second portion extending from the first portion toward the second side, the second portion disposed at an oblique angle relative to the first portion.

Implementations of this aspect of the disclosure may include one or more of the following optional features. In some implementations, the device includes a user interface.

In some implementations, a height of the third opening is greater than or equal to a height of the fourth opening.

In some implementations, another rack is disposed above the first receptacle and includes another first portion that extends parallel to the first portion of the rack and another second portion that extends non-parallel to the second portion of the rack.

In some implementations, the first portion of the rack extends perpendicular to the first side of the heated storage locker.

In some implementations, a first side wall and a second side wall respectively extend between the first side and the second side. The first support structure extends from the first side wall and a second support structure extends from the second side wall. The rack is supported at the first support structure and the second support structure. In some further implementations, the first support structure and the second support structure respectively include guide rails.

In some implementations, the rack is removable from the heated food storage locker via the second opening.

In some implementations, the rack includes a plurality of bars extending parallel to one another. In some further implementations, a space between adjacent bars of the plurality of bars of the rack is smaller than a size of the food product.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a front view of an example food management system in accordance with the principles of the present disclosure.

FIG. 2A is a perspective view of an example heated storage device in accordance with the principles of the present disclosure.

FIG. 2B is a front view of the heated storage device of FIG. 2A.

FIG. 2C is a rear view of the heated storage device of FIG. 2A.

FIG. 2D is a side view of the heated storage device of FIG. 2A.

FIG. 3 is a sectional view of the heated storage device of FIG. 2A.

FIG. 4 is top plan view of a rack of the heated storage device of FIG. 2A.

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

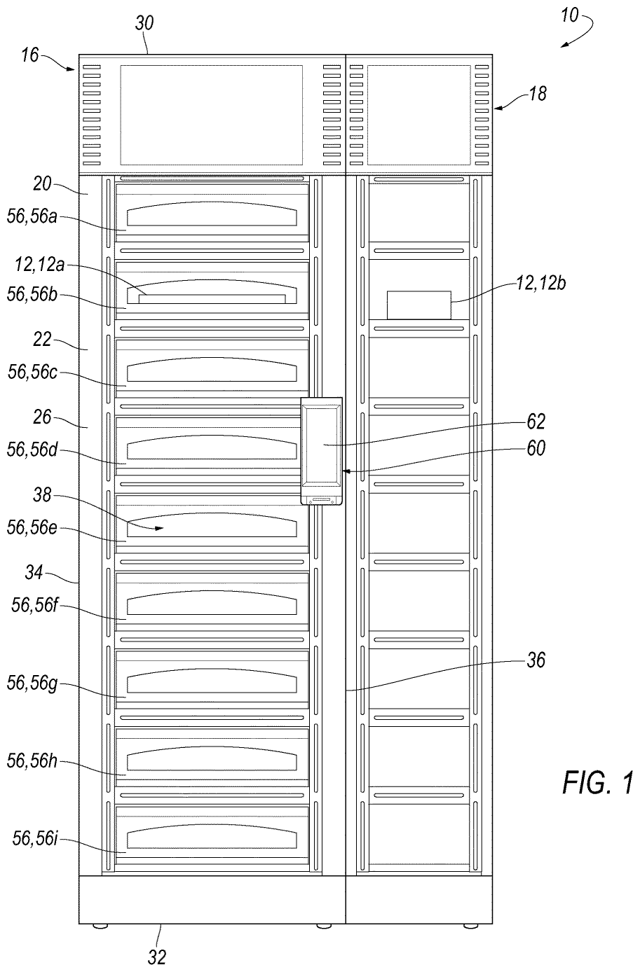

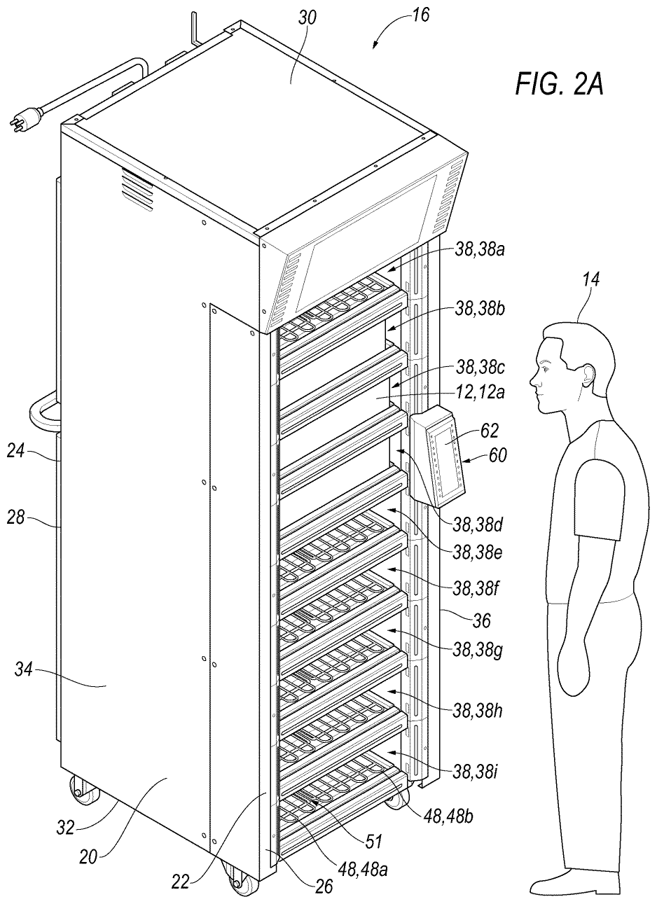

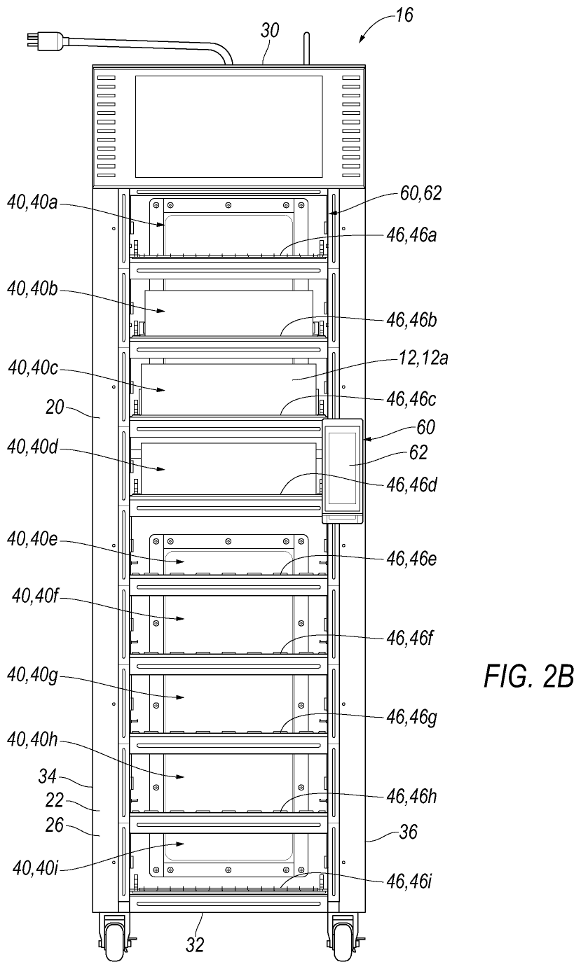

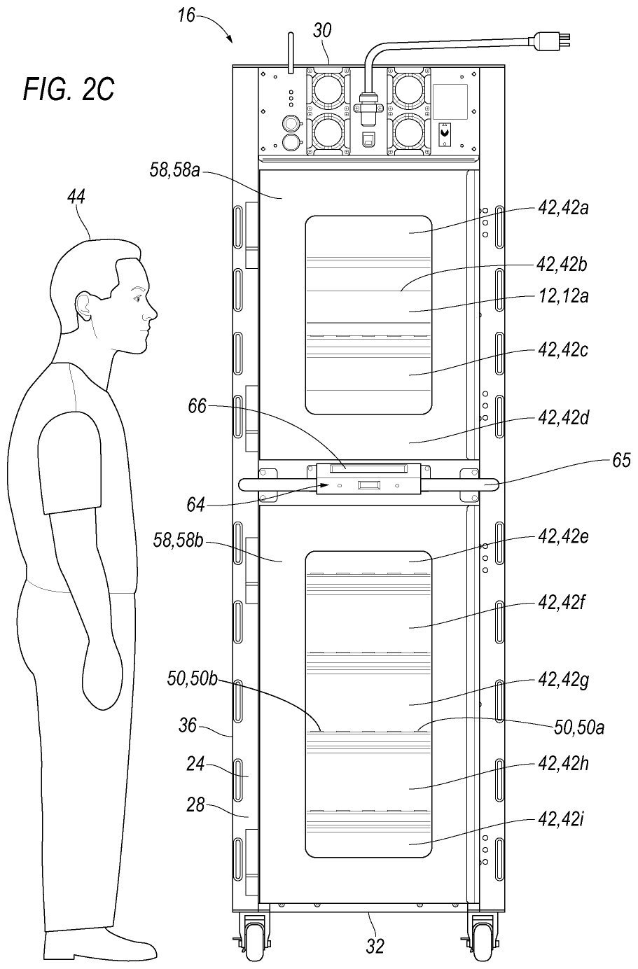

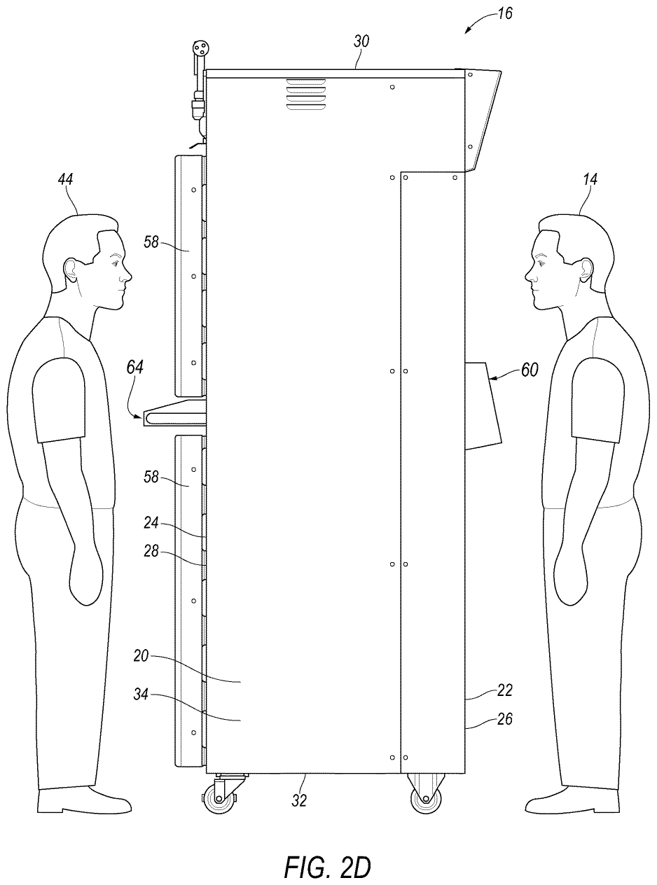

Referring to FIGS. 1 and 2A, a food management system 10 is illustrated in accordance with the principles of the present disclosure. The food management system 10 may be disposed in, and utilized by, a restaurant or other similar establishment to manage the ordering of food products 12 by, and the delivery of food products 12 to, a first user 14 such as, for example, a consumer or a third-party delivery service. For example, in some implementations, the food management system 10 may be utilized by a pizza-making restaurant. In this regard, while the food products 12 may be generally shown and described herein as including food products like pizzas, breadsticks, chicken, sauces, dessert items and beverages, for example, it will be appreciated that the food products 12 may include other items within the scope of the present disclosure. Further, the food products 12 may include at least a first food product 12a and a second food product 12b. The first food product 12a may be associated with items intended to remain hot or warm in a heated environment, such as pizzas, breadsticks, chicken, and the like. Meanwhile, the second food product 12b may be associated with items intended to remain at ambient temperature, or cold in a non-heated environment, such as sauces, dessert items, beverages, and the like. In some examples, the second food products 12b, or other items, do not need to be heated, and may include non-food products such as shirts, hats or other merchandise, plates and other eating utensils, and the like.

The food management system 10 includes a heated storage device or storage locker 16 configured to hold first food products 12a in a heated environment for later pickup by the first user 14. Further, the food management system 10 may include a non-heated storage device or non-heated shelving unit 18 configured to hold second food products 12b in a cooled or ambient environment for later pickup by the first user 14. As discussed further below, the food management system 10 is configured to manage orders associated with the food products 12 to instruct the restaurant to make the food products 12, direct placement of the food products 12 into the heated storage locker 16 and/or the non-heated shelving unit 18, and to control and indicate pickup of the food products 12 from the heated storage locker 16 and/or the non-heated shelving unit 18 by the first user 14.

The heated storage locker 16 and the non-heated shelving unit 18 represent separate units disposed in the restaurant and may be disposed remote from one another or adjacent to one another, such as in the illustrated example. Further, the heated storage locker 16 includes one or more cabinets 20 arranged in respective columns and/or stacks. In this regard, while the heated storage locker 16 is shown and described herein as including one set or stack of cabinets 20, it should be appreciated that the heated storage locker 16 may include more than one set or stack of cabinets 20 without deviating from the context of the present disclosure.

With reference to FIGS. 2A-2D, the storage locker 16 includes a first side or front surface 22 and a second side or rear surface 24 opposite the first side 22. A front panel or wall 26 may be disposed at the first side 22 of the storage locker 16, and a rear panel or wall 28 may be disposed at the second side 24 of the storage locker 16. Further, the storage locker 16 may include an upper panel or wall 30 that extends between the first side 22 and the second side 24 at an upper portion of the storage locker 16, a lower panel or wall 32 that extends between the first side 22 and the second side 24 at a lower portion of the storage locker 16 opposite the upper portion, a first side panel or wall 34 that extends between the first side 22 and the second side 24 at a first side portion of the storage locker 16, and a second side panel or wall 36 that extends between the first side 22 and the second side 24 at a second side portion of the storage locker 16 opposite the first side portion. A plurality of chambers or locker receptacles 38 extend between the first side 22 and the second side 24 of the storage locker 16 to define the cabinets 20 and are respectively configured to hold first food products 12a. For example, the locker receptacles 38 may be sized to accommodate two stacked pizza boxes and two side items like breadsticks, sauces, and the like. The front wall 26, rear wall 28, upper wall 30, lower wall 32, first side wall 34, and second side wall 36 may collectively surround and/or define the plurality of locker receptacles 38. While the storage locker 16 is shown and described herein as defining a substantially rectangular prism, it should be appreciated that the storage locker 16 may define other shapes surrounding the plurality of locker receptacles 38 without deviating from the context of this disclosure.

In the illustrated example, the storage locker 16 includes nine individual locker receptacles 38a-38i that are vertically disposed or stacked relative to one another between the lower wall 32 of the storage locker 16 and the upper wall 30 of the storage locker 16. A first locker receptacle 38, 38a is positioned closest to the upper wall 30 and a ninth locker receptacle 38, 38i is positioned closest to the lower wall 32. It should be appreciated that the heated storage locker 16 may include any suitable number of locker receptacles 38 without deviating from the context of this disclosure.

The first side 22 of the storage locker 16 includes a plurality of first locker openings 40 extending through the front wall 26 and in communication with the individual locker receptacles 38. In this regard, the plurality of first locker openings 40 may provide the first user 14 access to the plurality of locker receptacles 38. Further, each first locker opening 40 corresponds to a respective locker receptacle 38. The second side 24 of the storage locker 16 includes a plurality of second locker openings 42 extending through the rear wall 28 and in communication with the individual locker receptacles 38. In this regard, the plurality of second locker openings 42 may provide a second user 44 access to the plurality of locker receptacles 38. The second user 44 may be an employee or other person affiliated with the restaurant or establishment at which the food management system 10 is located. For example, the second side 24 of the storage locker 16 may face a kitchen or prep area of the venue so that the second user 44 may be granted access to the locker receptacles 38 via the second locker openings 42 while in the kitchen or prep area, while the first side 22 of the storage locker 16 faces a lobby or reception area of the venue so that the first user 14 may be granted access to the locker receptacles 38 via the first locker openings 40 while in the lobby or reception area. Further, each second locker opening 42 corresponds with a respective locker receptacle 38, such that each locker receptacle 38 extends between a corresponding first locker opening 40 and a corresponding second opening 42.

In the illustrated example, the storage locker 16 includes nine first locker openings 40a-40i, with each first locker opening 40 corresponding to a respective individual locker receptacle 38. An uppermost first locker opening 40, 40a is positioned closest to the upper wall 30 and a lowermost first locker opening 40, 40i is positioned closest to the lower wall 32. Similarly, the storage locker 16 includes nine second locker openings 42a-42i, with each second locker opening 42 corresponding to a respective individual locker receptacle 38. An uppermost second locker opening 42, 42a is positioned closest to the upper wall 30 and a lowermost second locker opening 42, 42i is positioned closest to the lower wall 32. It should be appreciated that the heated storage locker 16 may include any suitable number of first locker openings 40 and corresponding second locker openings 42 without deviating from the context of this disclosure.

Each locker receptacle 38 includes a respective receiving structure or rack or shelf 46 such that the storage locker 16 includes a plurality of racks 46. Each rack 46 may be configured to accept and hold one or more food products 12 disposed in the locker receptacle 38, and specifically, one or more first food products 12a. In this regard, the racks 46 may extend at least partially between the first side 22 and the second side 24 of the storage locker 16 and be spaced from one another between the lower wall 32 and the upper wall 30. Further, each rack 46 may be fixedly or removably attached to one or more of the front wall 26, rear wall 28, upper wall 30, lower wall 32, first side wall 34, and second side wall 36 such that each rack 46 remains rigidly disposed at a lower portion of each locker receptacle 38. Moreover, respective end portions of the racks 46 may define or correspond to the first locker openings 40 and the second locker openings 42 such that the first locker openings 40 may be disposed between end portions of adjacent racks 46 at or near the first side 22 of the storage locker 16 and the second locker openings 42 may be disposed between opposite end portions of adjacent racks 46 at or near the second side 24 of the storage locker 16.

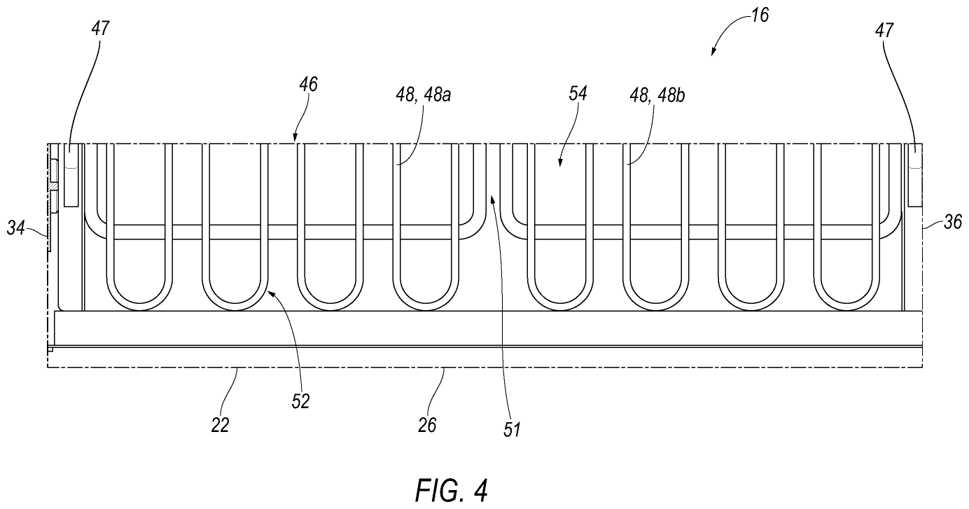

Support structure 47, such as respective rails or mounting pegs or tabs or hooks or knobs, may extend from the first side wall 34 and the second side wall 36 at lower portions of each locker receptacle 38 (FIG. 4). Support structure 47 for adjacent locker receptacles 38 may be vertically spaced from one another to provide substantially uniform spacing for food products 12 between adjacent locker receptacles 38. The support structure 47 associated with each locker receptacle 38 is configured to slidably receive the corresponding rack 46 so that the rack 46 and any food products 12 disposed at the rack 46 rest on the support structure 47. The rack 46 may extend over and along the support structure 47 to provide a smooth or continuous upper support surface for the food products 12 and thus prevent the food products 12 from catching on any edges or surfaces when removed by the first user 14 through the first locker opening 40. That is, racks 46 and corresponding support structure 47 are free of snag points so as to enable easy depositing and retrieval of the food products 12 into and out of the locker receptacles 38. Moreover, each rack 46 may be removable from the storage locker 16 via a corresponding second locker opening 42, such as by sliding the rack 46 off the support structure 47 and through the second locker opening 42. This allows the racks 46 to be more easily replaced and/or cleaned.

In the illustrated example, the storage locker 16 includes nine racks 46a-46i, with each rack 46 corresponding to a respective locker receptacle 38. A first rack 46, 46a is positioned closest to the upper wall 30 and a ninth rack 46, 46i is positioned closest to the lower wall 32. It should be appreciated that the heated storage locker 16 may include any suitable number of racks 46 without deviating from the context of this disclosure.

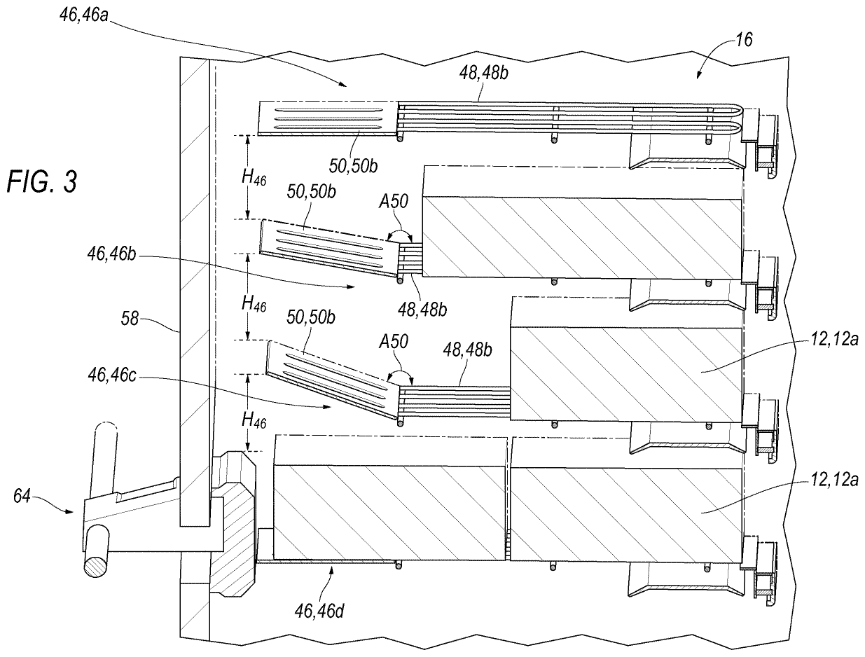

With reference to FIGS. 3 and 4, each rack 46 of the plurality of racks 46 may include a first portion or surface 48 and a second portion or surface 50. With the rack 46 disposed within the locker receptacle 38, the first portion 48 of the rack 46 may be closest to, and optionally abut, the first locker opening 40, with the first portion 48 extending toward the second locker opening 42 of the locker receptacle 38. Further, the first portion 48 of the rack 46 may extend substantially perpendicular to the first side 22 of the storage locker 16, thus providing a substantially flat configuration for the first portion 48 of the rack 46 to accept and hold the food products 12 disposed in the locker receptacle 38. This may provide visibility of the food products 12 to the first user 14 through the first locker opening 40 and allow for the first user 14 to easily remove the food products from the rack 46 through the first locker opening 40.

The second portion 50 of the rack 46 extends from the first portion 48 toward the second opening 42 and optionally abuts the second opening 42. For one or more of the racks 46 disposed in the storage locker 16, the second portion 50 of the rack 46 may extend from the first portion 48 toward the second locker opening 42 at an oblique angle A50 relative to the first portion 48. Other racks 46 may have a first portion 48 and a second portion 50 that extend substantially parallel or co-planar to one another. Each angled rack 46 may have a different oblique angle A50 between the first portion 48 and the second portion 50. In other words, the specific oblique angle A50 may vary among each specific rack 46 to maintain a minimum clearance or access height H46 between adjacent racks 46 and thus maintain access into each locker receptacle 38 through the second locker openings 42. For example, the minimum access height H46 may accommodate two stacked pizza boxes. That is, the minimum access height H46 may be at least 4 inches or greater, at least 6 inches or greater, at least 8 inches or greater, and the like. The angled racks 46 may accommodate structure or obstructions disposed at the second side 24 of the storage locker 16, as discussed further below.

Moreover, the oblique angle A50 of the second portion 50 of the rack 46 relative to the first portion 48 may be configured to guide the first food product 12a from the second portion 50 of the rack toward the first portion 48 of the rack 46. In other words, the second portion 50 is angled or sloped relative to the first portion 48 so that, when the food product 12 is deposited in the locker receptacle 38 through the second locker opening 42 by the second user 44, the food product 12 may be placed on the second portion 50 and the food product 12 may slide downward along the second portion 50 toward the first portion 48 before ultimately coming to rest at the first portion 48. For example, and as shown in FIG. 3, the oblique angle A50 of the second portion 50 relative to the first portion 48 is greater than 90 degrees, such as at least 110 degrees or greater, at least 135 degrees or greater, at least 150 degrees or greater, at least 170 degrees or greater, and the like.

In some examples, the rack 46 may comprise two or more pieces or portions or halves, with a gap or seam 51 separating each portion of the rack 46. The gap 51 may extend between the first locker openings 40 and the second locker openings 42. Thus, the rack 46 includes a first half or portion mounted to the first side wall 34 and a second half or portion mounted to the second side wall 36. For example, the support structure 47 may include cantilever support arms extending from the respective side walls and configured to support each half of the rack 46. In this regard, the first portion 48 may include a first section 48a adjacent to the first side wall 34 and a second section 48b adjacent to the second side wall 36. The first section 48a and the second section 48b may be independently mounted within the locker receptacle 38 so that the first section 48a is disengaged and independent from the second section 48b. In a similar manner, the second portion 50 may include a first section 50a adjacent to the first side wall 34 and a second section 50b adjacent to the second side wall 36.

The first section 50a and the second section 50b may be independently mounted within the locker receptacle 38 so that the first section 48a is disengaged and independent from the second section 48b. Alternatively, the first section 50a of the second portion 50 may be rigidly connected to and/or integrally formed with the first section 48a of the first portion 48. In this regard, the first section 50a of the second portion 50 may be free of mounting hardware, thus relying on the mounting hardware included at the first section 48a to support both first sections 48a, 50a, simultaneously, within the locker receptacle 38. In a similar manner, the second section 50b of the second portion 50 may be rigidly connected to and/or integrally formed with the second section 48b of the first portion 48. In this regard, the second section 50b of the second portion 50 may be free of mounting hardware, thus relying on the mounting hardware included at the second section 48b of the first portion 48 to support both second sections 48b, 50b, simultaneously, within the locker receptacle 38.

The rack 46 may provide any suitable surface configured to hold the food product 12. Further, the first portion 48 may provide a surface that is identical or dissimilar than a surface provided by the second portion 50. For example, both the first portion 48 and the second portion 50 of the rack 46 may be configured as a wire rack that includes a plurality of bars 52 extending between the first locker opening 40 and the second locker opening 42. The plurality of bars 52 may be rigidly connected to one another and collectively mounted to the storage locker 16 at the locker receptacle 38. The plurality of bars 52 may include any material configured to interface with the food product 12, such as stainless steel, 1010 steel, and the like. Further, the plurality of bars 52 may be nickel-chrome plated such as for aesthetic and durability purposes. A gap or a space 54 between adjacent bars 52 of the plurality of bars 52 and the gap 51 between adjacent portions of the rack 46 may be sized smaller than a size of the food product 12 so as to prevent the food product 12 from falling between adjacent bars 52. For example, to accommodate a sauce cup placed on the rack 46, a width of the gap 51 between adjacent portions of the rack 46 and a width of the space 54 between adjacent bars 52 may be about 2 inches or less, about 1.5 inches or less, about 1 inch or less, and the like. In another example, both the first portion 48 and the second portion 50 of the rack 46 may be configured as a solid base or surface, such as a rigid metallic plate or sheet metal. The metallic plate may include a plurality of apertures or channels extending through the metallic plate to reduce weight and provide increased airflow between locker receptacles 38. In yet another example, the first portion 48 may be configured as a wire rack and the second portion 50 may be configured as a metallic plate.

With continued reference to FIGS. 1-2D, the storage locker 16 may also include a plurality of first doors 56 that are movably coupled to the storage locker 16 at or near the first side 22, with each first door 56 corresponding to a respective locker receptacle 38 such that each first door 56 (i) prevents access to one of the plurality of locker receptacles 38 through the corresponding first locker opening 40 in a closed position and (ii) allows access to the one of the plurality of locker receptacles 38 through the corresponding first locker opening 40 in an open position. In this regard, each first locker opening 40 may further include a sensor to detect whether the corresponding first door 56 is in the open position or the closed position. This configuration allows the first user 14 to access a desired locker receptacle 38 of the plurality of locker receptacles 38 by opening the first door 56 that corresponds to the first locker opening 40 at the desired locker receptacle 38.

The storage locker 16 may include nine first doors 56a-56i, with each first door 56 corresponding to a respective locker receptacle 38. An uppermost first door 56, 56a may be positioned closest to the upper wall 30 and a lowermost first door 56, 56i may be positioned closest to the lower wall 32. It should be appreciated that the heated storage locker 16 may include any suitable number of first doors 56 without deviating from the context of this disclosure, such as if one first door 56 covered two or more adjacent first locker openings 40 of corresponding adjacent locker receptacles 38.

The storage locker 16 may also include one or more second doors 58 that are movably coupled to the storage locker 16 at or near the second side 24 such that the second door 58, with each second door 58 corresponding to one or more corresponding locker receptacles 38, such that each second door 58 (i) prevents access to one or more of the plurality of locker receptacles 38 through the corresponding one or more second locker openings 42 in a closed position and (ii) allows access to the one or more locker receptacles 38 through the corresponding one or more second locker openings 42 in an open position. In the illustrated example, the storage locker 16 includes a first or upper second door 58, 58a that corresponds to at least the first locker receptacle 38a, a second locker receptacle 38b, a third locker receptacle 38c, and a fourth locker receptacle 38d. A second or lower second door 58, 58b corresponds at least to a fifth locker receptacle 38e, a sixth locker receptacle 38f, a seventh locker receptacle 38g, an eighth locker receptacle 38h, and the ninth locker receptacle 38i. Thus, the second user 44 may be granted access to more than one locker receptacle 38 at a time when opening one of the second doors 58.

A user interface 60 is disposed at the first side 22 of the storage locker 16 and does not block or interrupt or space the stack of locker receptacles 38 (FIG. 2B). In other words, the user interface 60 is disposed at the first side 22 of the storage locker 16 and alongside or adjacent the locker receptacles 38. This allows the locker receptacles 38 to occupy space at the most convenient and accessible height range of the storage locker 16 (e.g., for the first user 14 to retrieve food products 12 from the locker receptacles 38), while simultaneously providing access to the user interface 60 at the convenient and accessible heights (e.g., for the first user 14 to interact with the user interface 60). For example, the user interface 60 may be positioned adjacent to one or more of the first doors 56 at the front wall 26 of the storage locker 16. The user interface 60 includes a display screen 62 and may further include a touchscreen, a keypad, a scanner, and the like. In this regard, the first user 14 may interact with the user interface 60 in a variety of ways, such as to view messages displayed at the display screen 62 and to provide inputs at the touchscreen, the keypad, the scanner, and the like.

An employee interface 64, which may also be referred to generally as a device or a user interface 64, is disposed at the second side 24 of the storage locker 16 between respective locker receptacles 38, such as between the fourth locker receptacle 38d and the fifth locker receptacle 38e, such that the employee interface 64 is at a highly visible and accessible height for the second user 44 interacting with the employee interface 64 (FIG. 2C). For example, the employee interface 64 may be disposed between the upper second door 58a and the lower second door 58b at the rear wall 28 of the storage locker 16. In some examples, a grab bar or handle 65 may be disposed between the upper second door 58a and the lower second door 58b so that the second user 44 may easily maneuver the storage locker 16 within the restaurant. The handle 65 is robust enough and positioned at an accessible position for routine activities. The employee interface 64 may be disposed at and/or integrated with the handle 65 to make efficient use of the space occupied by the handle 65. The employee interface 64 includes a display screen 66 that may further include a touchscreen, a keypad, a scanner, and the like. In this regard, the second user 44 may interact with the employee interface 64 in a variety of ways, such as to view messages displayed at the display screen 66 and to provide inputs at the touchscreen, the keypad, the scanner, and the like.

With reference to FIG. 3, and as stated above, the varying oblique angles A50 among the second portions 50 of the plurality of racks 46 are configured to maintain access into each locker receptacle 38 via each second locker opening 42 despite obstructions disposed at the second side 24 of the storage locker 16. Further, the varying oblique angles A50 prevent obstructions at the second side 24 of the storage locker 16 from limiting or restricting the quantity of locker receptacles 38 included in the storage locker 16. For example, obstructions at the second side 24 of the storage locker 16 may include the employee interface 64 as well as any mounting structures associated with the employee interface 64. Disposing the employee interface 64 between the fourth locker receptacle 38d and the fifth locker receptacle 38e, as shown in the illustrated example, may partially obstruct one or more of the second locker openings 42, such as the second locker opening 42d at the fourth locker receptacle 38d.

Put another way, the first locker openings 40 of the locker receptacles 38 may be evenly spaced relative to one another at the first side 22 of the storage locker 16 to maximize usable space accessible to the first user 14. The employee interface 64 may cause at least some of the second locker openings 42 at the second side 24 of the storage locker 16 to be vertically offset or misaligned from the first locker opening 40 of the corresponding locker receptacle 38. For example, the first locker opening 40d of the fourth locker receptacle 38d may be substantially aligned with the employee interface 64 and the second locker opening 42d of the fourth locker receptacle 38d may be disposed or positioned above the employee interface 64 and higher than the first opening 40d. That is, the fourth locker receptacle 38d may extend between the locker opening 40d (e.g., a first opening 40) and the locker opening 42d (e.g., second opening 42), with the locker opening 42d disposed at least partially vertically above the locker opening 40d, and the third locker receptacle 38c may extend between the locker opening 40c (e.g., third opening 40) and the locker opening 42c (e.g., fourth opening 42) with the locker opening 42c disposed at least partially vertically above the locker opening 40c To accommodate this disparity, the second portion 50 of the third rack 46c at the third locker receptacle 38c above the fourth locker receptacle 38d may be disposed relative to the first portion 48 at an oblique angle A50 that maintains sufficient access into the fourth locker receptacle 38d. The third rack 46c may maintain the clearance height H46 between a distal end of the second portion 50 of the third rack 46c and the employee interface 64 that sufficiently accommodates placing the food product 12 in the fourth locker receptacle 38d.

Further, the second rack 46b of the second locker receptacle 38b may be angled to accommodate the angled third rack 46c, such that at least the clearance height H46 is maintained between the second rack 46b and the third rack 46c. In these examples, another rack 46 (e.g., the second rack 46b) may be disposed above the locker receptacle 38 (e.g., third locker receptacle 38c) and includes another first portion 48 that extends parallel to the first portion 48 of the rack 46 (e.g., the third rack 46c) and another second portion 50 that extends non-parallel to the second portion 50 of the rack 46 (e.g., third rack 46c). The oblique angle A50 of the second rack 46b may be greater than the oblique angle A50 of the third rack 46c. Thus, the second portion 50 of each rack 46 may be disposed at any suitable angle relative to the first portion 48 to maintain at least the minimum clearance H46 between each adjacent rack 46 of the storage locker 16. In this regard, each second opening height H46 at each corresponding second locker opening 42 is configured to maintain sufficient space for the food product 12 to enter into each corresponding locker receptacle 38. Further, it should be appreciated that each second locker opening height H46 at each corresponding second locker opening 42 may be equal or uniform or may vary. For example, the height H46 of one locker opening 40 (e.g., the third locker opening 40c) may be greater than or equal to the height H46 of another locker opening 42 (e.g., the second locker opening 40b).

Optionally, the food management system and food locker may utilize characteristics of the food management systems and lockers described in U.S. Pub. No. US-2022-0383250, which is hereby incorporated herein by reference in its entirety.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A heated food storage locker comprising:
a first side including a first opening;
a second side opposite the first side, the second side including a second opening;
a receptacle extending between the first opening and the second opening; and
a rack disposed in the receptacle and configured to support a food product within the receptacle, the rack including a first portion extending from the first side toward the second side and a second portion extending from the first portion toward the second side, the second portion disposed at an oblique angle relative to the first portion.

2. The heated food storage locker of claim 1, further comprising a user interface disposed at the second side a first vertical distance between the user interface and an end of the second portion of the rack distal from the first portion greater than or equal to a second vertical distance between the end of the second portion of the rack and an end of an adjacent rack.

3. The heated food storage locker of claim 1, wherein the first side includes a plurality of first openings that are uniformly spaced relative to one another along the first side, the second side includes a plurality of second openings that are not uniformly spaced relative to one another along the second side, and individual receptacles of a plurality of receptacles extending between corresponding ones of a plurality of first openings and corresponding ones of a plurality of second openings.

4. The heated food storage locker of claim 3, wherein individual racks of a plurality of racks are disposed in corresponding ones of the plurality of receptacles, the first portions of the plurality of racks extending parallel to one another, and the second portions of the plurality of racks extending non-parallel to one another to accommodate non-uniform spacing of the plurality of second openings.

5. The heated food storage locker of claim 1, wherein the first portion of the rack extends perpendicular to the first side of the heated food storage locker.

6. The heated food storage locker of claim 1, wherein a first side wall and a second side wall respectively extend between the first side and the second side, a first support structure extending from the first side wall within the receptacle and a second support structure extending from the second side wall within the receptacle, the rack supported at the first support structure and the second support structure.

7. The heated food storage locker of claim 6, wherein the first support structure and the second support structure respectively include guide rails.

8. The heated food storage locker of claim 1, wherein the rack is removable from the receptacle via the second opening.

9. The heated food storage locker of claim 1, wherein the rack includes a plurality of bars extending parallel to one another.

10. The heated food storage locker of claim 9, wherein a space between adjacent bars of the plurality of bars of the rack is smaller than a size of the food product.

11. A heated food storage locker comprising:
a first side including a first opening and a second opening;
a second side opposite the first side, the second side including a third opening and a fourth opening;
a device disposed at the second side and at least partially vertically aligned with the first opening;
a first receptacle extending between the first opening and the third opening, the third opening disposed at least partially vertically above the first opening;
a second receptacle extending between the second opening and the fourth opening, the fourth opening disposed at least partially vertically above the second opening; and
a rack disposed between the first receptacle and the second receptacle and configured to support a food product within the second receptacle, the rack including a first portion extending from the first side toward the second side and a second portion extending from the first portion toward the second side, the second portion disposed at an oblique angle relative to the first portion.

12. The heated food storage locker of claim 11, wherein the device comprises a user interface.

13. The heated food storage locker of claim 11, wherein a height of the third opening is greater than or equal to a height of the fourth opening.

14. The heated food storage locker of claim 11, wherein another rack is disposed above the second receptacle and includes another first portion that extends parallel to the first portion of the rack and another second portion that extends non-parallel to the second portion of the rack.

15. The heated food storage locker of claim 11, wherein the first portion of the rack extends perpendicular to the first side of the heated food storage locker.

16. The heated food storage locker of claim 11, wherein a first side wall and a second side wall respectively extend between the first side and the second side, a first support structure extending from the first side wall and a second support structure extending from the second side wall, the rack supported at the first support structure and the second support structure.

17. The heated food storage locker of claim 16, wherein the first support structure and the second support structure respectively include guide rails.

18. The heated food storage locker of claim 11, wherein the rack is removable from the heated food storage locker via the second opening.

19. The heated food storage locker of claim 11, wherein the rack includes a plurality of bars extending parallel to one another.

20. The heated food storage locker of claim 19, wherein a space between adjacent bars of the plurality of bars of the rack is smaller than a size of the food product.
